(19) United States
(12) Patent Application Publication
(10) Pub. No.: US 2004/0237261 A1
(43) Pub. Date: Dec. 2, 2004

(54) Marking tool

(76) Inventor: Michael F. Rouse, Blair, NE (US)

Correspondence Address: MICHAEL F. ROUSE, 9906 PINE CREST DR., BLAIR, NE, 68008, US

(21) Appl. No.: 10/425,016

(22) Filed: Apr. 25, 2003

Related U.S. Application Data
(63) Continuation-in-part of application No. 09/672,796, filed on Sep. 28, 2000, now abandoned.

(51) Int. Cl. B43K 25/00

(52) U.S. Cl. 24/10 R

(57) ABSTRACT

A tool holder having a finger strap having ends adjustably attached forming an adjustable loop to fit snuggly around fingers of different thickness. The strap is resilient for comfort and its ends are attached by a hook and loop assembly. A tool strip has spaced ends attached to the outer side of the finger strap whereby an opening between the strap and strip can receive a pencil or other tool. This opening is small enough with respect to the diameter of the tool so that the tool is firmly held between the strap and the strip when in use. A modification provides for adjustable spacing, along the finger strap, of attached portions of the ends of the tool strip so that tools of varying thickness can be received in the opening. This adjustable attachment is of the hook and loop type.

### FIELD OF THIS INVENTION

This invention is in the field of finger mounted holders of small tools such as pencils, pens and brushes.

### BACKGROUND

In the history of this field there have been many devices for use in word writing, or painting. But none, ever, to my knowledge, are for the special use of very active and vigorous workers, such as carpenters, for marking work pieces before making cuttings, hammering or drilling.

A carpenter, for example, will tend to keep his pencil in a pencil pocket in overalls, way up at the chest level. This wastes much time in: (1) reaching to this distant pencil-storage pocket, (2) withdrawing the pencil, (3) moving one's hand, with the pencil, to the work, (4) moving one's hand and pencil back to the pencil-storage pocket, (5) guiding insertions for the pencil into the pencil-storage pocket place, and (6) then moving one's hand back to grip a tool, such as a saw, hammer, or drill.

A marker holder has long been needed that will not interfere with good gripping of a saw, for example, right while the marker-holder remains on the worker's hand. An 1862 pioneer patent to J. Jacobs shows a trustro-cunical metal sleeve, and is one of the many to use a thimble-like wedge-on finger receiver, but, such would fall quickly off the end of the finger in vigorous carpentry. However, it was a good idea for word writers. The metal pencil holder of this 1862 way, if used by a carpenter, might accidentally scratch and damage work surfaces, or catch on, and cut the carpenter's left hand in vigorous work. Nevertheless, it would do for a work-writer or an artist.

Another finger-held-instrument for word writers, and their handwriting, is in U.S. Pat. No. 343,391, Jun. 8, 1886 to F. P. Peller. This shows a finger grip of spring steel, which grips a finger with a split ring, whereby the ring can yield somewhat, so as to be passed across hard joints of one's finger to get to the desired position.

The hard edges of the protruding pencil holder portion of U.S. Pat. No. 343,391 might be harmless in word writing use. However, in some cabinet carpentry, and in some furniture making, such hard edges could accidentally gouge an exterior wooden or painted surface, or injure the carpenter. In U.S. Pat. No. 343,391 the finger holder itself would tend to be uncomfortably strong, in Its pressure, or of such a loose fit as to cause the pencil to flop-out of its storage place. The number of steel finger sizes needed for close fit would be great. This would make tooling and marketing costly. The storage place is at the finger top in U.S. Pat. No. 343,891 of 1988. However, in U.S. Pat. No. 343,891 no writing is taught to be done with the pencil on the top of a finger but below only.

Over a century after this 1886 patent came U.S. Pat. No. 4,738,556, Apr. 19, 1988. This 1988 patent held a writer's ballpoint pen. It shows a good, wrap around, hook and loop, adjustable finger strap. But, in the 1988 patent, the finger strap was not resilient, not yielding, and without elasticity. The pen portion of the 1988 patent held a pen in a permanent way with no possibility of exchange for a fresh pen although the ink supply would run out as it was a very short pen. In use, the end of the pen-carrying finger in the 1988 patent is always covered. This is all right for pen writing, but most tool handlers would want their fingertips free and uncovered for better grip on a saw, hammer, or other tool.

### OBJECTIVES

A primary objective is to provide a marking system capable of providing maximum comfort during long work hours with accuracy of marking.

Another objective is to provide the possibility of firm grip on the marker, holding it steady and stable for marks that are dark and easily seen.

Another objective is to offer a marking system in which stability is assisted by the exertion of constant, comfortable pressure because of elasticity in its finger strap in cooperation with length-of-strap adjustability.

Another objective is to provide a pencil-holding strip, which is soft and not in danger of cutting, accidentally, the work pieces, or the user's left wrist.

A pencil groove in the finger strap helps, herein, to stabilize the pencil.

Very important is the objective of capability of holding the pencil on the backside of one's finger simultaneously with the gripping of a saw, or other tool with the same hand. The pencil herein is held in a position out-of-the-way, and not interfering with good grip on a saw, hammer or drill, for examples.

Experiments were made in which the longest finger overlaps the index finger. The longest finger then presses the pencil strip, and pencil, firmly toward the pencil holding index finger.

In further experiments it was found that the pressure from the longest finger is made especially comfortable if the pencil is on the longest finger side of the index finger with the pencil in approximately a “10 o'clock like” position when the index finger is looked at from it's outer end.

For a time, this 10 o'clock position possibility seemed very well, and the construction of the marker holder hereof made it possible, and made it also seemingly fortunate.

But, it was discovered in still later experiments, that, with the pencil above the middle of the top of the index finger, for some reason the top position worked best.

Finally, it was realized that the rearward end of the pencil is stabilized better in the top position by support from the index finger. Such support does not occur when the pencil is at the side of the index finger. So the support in the top position was discovered to be more important than extra comfort in The 10 o'clock side-position from the lesser pulling of the longest finger out of relaxed position.

So, it is an objective, the method of use herein, is to have the marker above the middle of the top of the index finger.

In addition the system hereof includes pressing the thumb upwardly toward the index finger, and in a direction toward the longest finger position.

An objective is to have the pencil holding strip herein anchored to the finger strap in two widely spaced places so that it does not twist. This is an important discovery. Experiments showed that a pencil-holding elastic or adjustable length marker-receiving loop attached to the strap along only one line would twist excessively. So, making two loops, a large bottom loop and a smaller upper loop, attached along a line where they touched, like a child's snowman in planar outline, proved the “snowman” way impractical. Another of many, many experimental developments was leading to the most stable way.

Another objective is to provide a tool holder useful for holding a pen-pencil, paint brush, a special knife and a special saw, a screwdriver and a sharp ice-pick-like hole making tool

A further objective is to provide for automatic tightening of grip on the held tool simultaneously with tightening of a finger-strap.

### DESCRIPTION OF DRAWINGS

FIG. 1 is a side view of thumb, index finger, and longest finger of a user holding the marker holder and pencil, hereof.

FIG. 2 is a view showing the system of FIG. 1, as seen looking rearward in alignment with the pencil.

FIG. 3 is a top view of the holder and pencil with the strap stretched out.

FIG. 4 shows an adjustable length tool strip modification. FIG. 4 a View identical to FIG. 2 but with an adjustable hook and loop type attachment of one end of the tool strip to the finger strap. A side view of this FIG. 4 modification would be exactly like FIG. 1.

FIG. 5 is a top plan view of the adjustable length tool strip modification of FIG 4.

### DETAILED DESCRIPTION

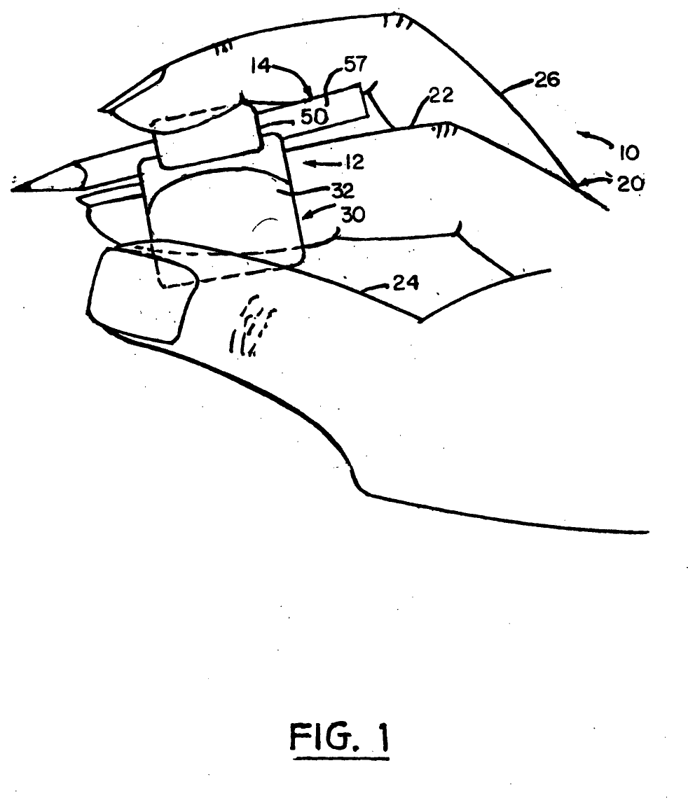

In FIG. 1, the marking system 10 hereof has a marker holder 12 holding a marker or marking tool 14. The system 10 further includes a human hand 20 with an index finger 22, a thumb 24, and a second and longest finger 26.

The longest finger 26 is on the side of the index finger 22, which is opposite to the thumb 24. The longest finger 26 is next to the index finger 22.

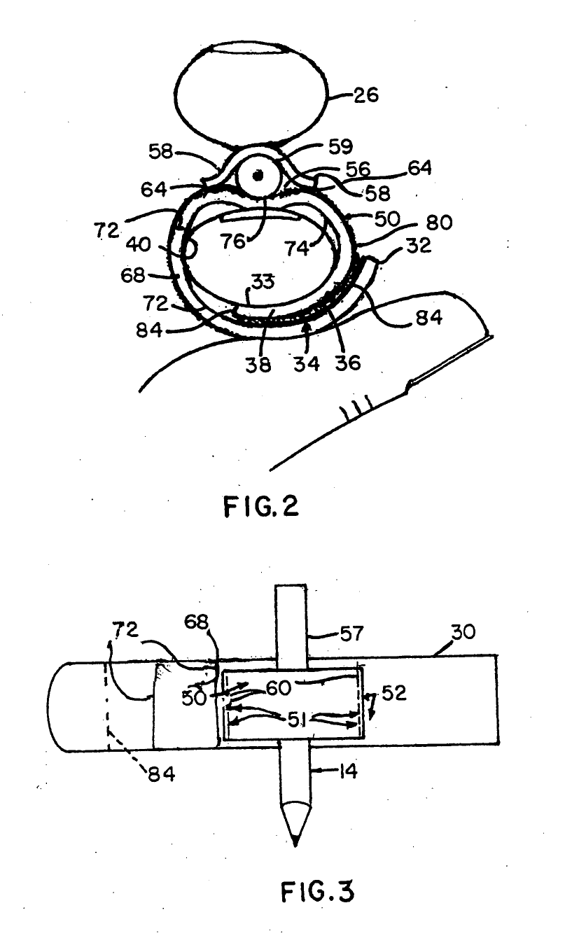

The finger holder 12 has a finger strap 30 having two strap end portions 32 and 33, FIG. 2.

An attaching means 34 has sections 36 and 38 on the strap end portions 32 and 33 respectfully, for attaching the end portions 32 and 33 together in any one of various positions to form a finger loop 40, FIG. 1, which fits closely around a finger, preferably the index finger 22.

The positions of the strap end portions 32, 33 and of the attaching means 34 control the sizes of the loop 40 allowing the loop 40 to fit fingers of different sizes adjustable.

A marking tool engaging strip 50 is on an opposite side of the strap 30 from the loop 40. A connection means 51 connects the strip 50 to a central area of the finger strap 30.

The strip 50 and the strap 30 provide a combination 52 of elements 30 and 50. This combination 52 provides an opening 56, FIG. 2, for receiving an elongated shank 57 of the marking tool 14. In FIG. 2, the strip 50 has two spaced attaching areas 58, and has a tool engagable section 59 between the two attaching areas 58.

The tool engagable section 59 engages the shank 57 of the marking tool or pencil 14 when such tool or pencil 14 is disposed in a use position between the attaching areas 58, and also is disposed between the tool engagable section 59 and the strap 30. The connecting means 50 connects the spaced strip attaching areas 58 to the strap 30.

The connecting means 51 can be stitching 60, FIG. 3, or can be cement or heat bonding, or other connecting means unseen at 64, FIG. 2. The strap 30 and strip 50 are of thermoplastic material.

In FIG. 2, a resilient section 68, having ends 72, is in the strap 30 and has an elasticity so as to exert a contraction force, when stretched, for tending to close the finger loop 40.

In FIG. 3, the strip 50, in manufacture and when not in use, is laid flat on the strap 30. In use, this way makes the strip 50 of a length to draw the strap up into two humps 74 for forming a groove 76 in the upper side of the strap 30 so as to receive, cradle, and stabilize, the marker 14.

The marking tool 14 can be a pencil, pen, crayon or felt-tipped marker. The tool shown is a pencil 14 with a shank portion 62 and a forward end 76.

The pencil 14 is of a short length such as mass produced for golfers.

In FIG. 2, the strap 30 has an outer surface of looped material being covered by tiny attachment loops 80.

The strap 30 has fixed thereto, a short flexible fastener 84, or fastener patch 84, FIGS. 2 and 3.

The fastener 84 has hooks 86 on a side thereof, which side faces the attachment loops 80, FIG. 2.

The fastener 84 is attached, in any suitable manner, to a side of the strap 30, which side faces the inner side of the finger loop 40.

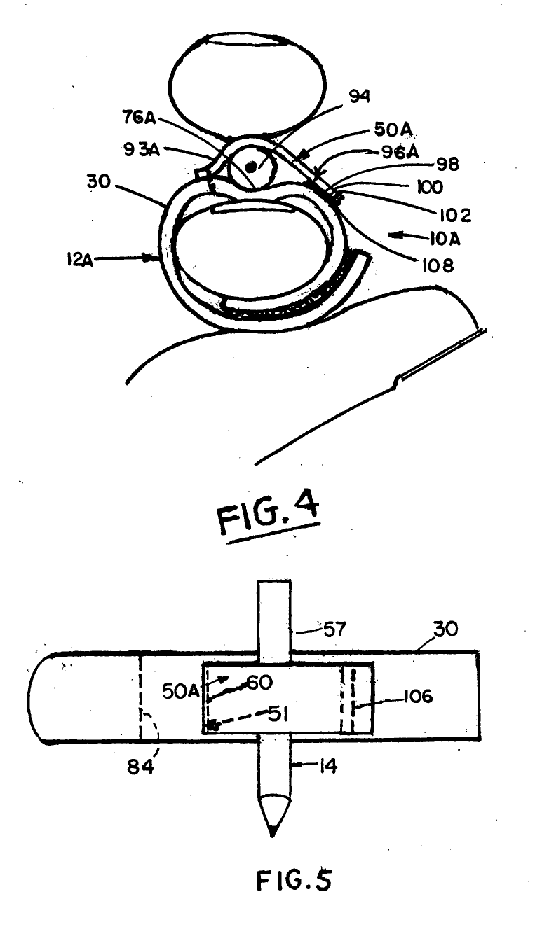

To receive tools of barging width, FIG. 4 an adjustably attached tool strip modified and tool holder 90 is shown in which the tool strip 92 is longer on one side of the tool than the other side of the tool 94 the attachment means 98 at the right side of drawing is of the hook and loop type in which I patch 100 has hooks extending toward the finger strap, can connect to loops 10 in an area faces the patch. The patch is glued or otherwise attached, such as stitching to the finger strap.

The adjustable finger strap modification of FIG. 4 allows the adjustment end of the strip to be able to be fastened to the finger strap in any of many positions at variable distance from the fixed end of finger strap.

1. A tool holder comprising: an elongated finger-strap assembly having a strap having two strap-end portions, attaching means having two attachment parts attached one to each of said strap end portions, said attachment parts being connectable together in any one of the various positions whereby said finger-strap assembly forms a finger receiving loop of variable size, a tool strip on the outer side of said loop, said strip having two spaced connecting positions spaced along a central portions of said finger-strap assembly, two spaced connecting means connecting said strip to said finger-strap assembly at said connecting positions whereby a tool receiving opening is provided between said finger-strap assembly and said tool strip, said strip being formed of a separate piece of material from said finger-strap assembly, said connecting positions being substantially spaced for receiving a tool there between, said two connecting means being disposed each of said connecting positions.
